(19) United States
(12) Patent Application Publication
(10) Pub. No.: US 2003/0145863 A1
(43) Pub. Date: Aug. 7, 2003

(54) Method for using denture reline material in conjunction with sport mouth guards

(75) Inventors: Dan E. Fischer, Sandy, UT (US); Dieter Schodel, Hamburg (DE)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: Ultradent Products. Inc.

(21) Appl. No.: 10/072,259

(22) Filed: Feb. 6, 2002

(51) Int. Cl. A61C 5/14

(52) U.S. Cl. 128/862

(57) ABSTRACT

Methods and kits for conforming protective mouth guards to the teeth of athletes to improve retention while providing added comfort and soft-tissue protection. One preferred method for conforming a protective mouth guard to fit securely to one or more teeth within a mouth comprises applying a curable denture reline material into a mouth guard and then inserting the mouth guard into a mouth to form a dental impression in the denture reline material. The reline material is then cured to maintain its form. Preferred reline materials are silicone-based. The mouth guards may be non-custom fitting, thermally deformable, and custom-fitted.

### BACKGROUND OF THE INVENTION

1. The Field of the Invention

The present invention relates generally to kits and methods for improving the retention and comfort of sport mouth guards within a mouth. More particularly, the invention relates to the use of an elastomeric material, such as a curable denture reline material, to help affix sport mouth guards to the teeth of athletes and provide increased cushioning.

2. The Relevant Technology

Protective mouth guards have become increasingly common for use in a variety of activities. The most common use of mouth guards is in contact sports, such as football, boxing and hockey, where a participant is frequently exposed to jarring impacts. Without the protection of a mouth guard, such impacts can be sufficient to loosen, dislodge or break one or more teeth. Such impacts can also damage soft tissues in the mouth as a participant's teeth are forcefully impacted against the soft tissues. Nevertheless, while mouth guards are clearly advantageous, poorly fitting mouth guards can fall out or otherwise provide inadequate protection, thereby negating or undermining their utility.

There are different varieties of mouth guards that are presently available on the commercial market. In general, they are mass-produced and come in a limited number of size ranges, often containing instructions for cutting a manufactured size to a shape to more closely fit a particular individual. As such, these mouth guards are not manufactured to conform to the actual teeth impressions of any particular individual.

Somewhat better fitting mouth guards comprise thermally deformable materials that can be temporarily softened and then made to roughly conform to a portion of the person's tooth, typically the occlusal surfaces. Examples of such mouth guards are the so-called “boil and bite” mouth guards. When the softened mouth guard is then placed in the mouth and the individual bites onto it, a limited impression of the occlusal surfaces of the teeth of the respective arches may result. In other words, it is only the occlusal surfaces of the mouth guard that provide any conformance to the teeth of the dental arch. Conformance of lingual and buccal surface of the mouth guard to the lingual, buccal, and interproximal regions of the teeth is not achieved.

For example, U.S. Pat. No. 3,312,218 to Jacobs describes such a large-scale production mouth guard for use in sports. The mouth guard is made from a thermoplastic material that conforms to the user's mouth and cushions the user's teeth from impact. The material is initially formed into a single U-shaped channel. It is heated to a temperature higher than body temperature. While in a soft and moldable condition, it is placed in the mouth and formed by biting, sucking, and applying pressure. At body temperature, it is shape retaining, tough, flexible, and resilient. For purposes of disclosing mouth guards that may be used in conjunction with the methods and kits of the present invention, the foregoing patent is incorporated herein by reference.

Such mouth guards conform generally to the shape of the mouth, but can easily be removed. In fact, dental injuries during contact sporting events are common when such conventional mouth guards accidentally fall out of a participant's mouth.

One attempt to remedy the problems associated with non-custom fitting mouth guards, or mouth guards that are only approximately custom-fitting, such as the aforementioned boil and bite mouth guards, is described in U.S. Pat. No. 4,955,393 to Adell. Adell discloses a mouth guard that comprises a one-piece body that has upper and lower troughs in a shape that corresponds generally to the upper and lower arches. The mouth guards of Adell are also substantially “U-shaped” (i.e., they have a front wall that covers the frontal surfaces of the person's teeth and a back wall that covers at least a portion of the lingual surfaces of the person's teeth). For purposes of disclosing mouth guards that may be used in conjunction with the methods and kits of the present invention, the foregoing patent is incorporated herein by reference.

Adell discloses two distinct embodiments of mouth guards that more closely approximate the size and shape of the person's teeth in order to provide a better fit. In a first embodiment, the mouth guard contains upper and lower liners comprising a deformable impression material that can conform to and form an impression of the user's teeth. The liners are mechanically locked to the mouth guard by interlocking material that extends along the edges of the troughs and by integral connections that extend between the troughs. There is no indication that the upper and lower liners of Adell are curable such that the level of deformability of the liners apparently remains substantially constant both before and after an impression is made of the person's teeth.

In a second embodiment, the mouth guard itself comprises a moisture-cured polyurethane material that is packaged in a hermetically sealed, moisture-proof package. No additional liner material is provided. Instead, the user simply removes the mouth guard from the package, inserts it into his or her mouth to make an impression of the teeth, and then allows the saliva or additional moisture to cause the mouth guard to cure in the desired shape. In this embodiment, the mouth guard itself is required to provide all the conformity and cushioning.

In view of the foregoing, there remains a need for improved methods and devices for effectively maintaining mouth guards within athlete's mouths during athletic events and for providing increased and more reliable cushioning of the user's teeth.

### SUMMARY OF THE INVENTION

The present invention relates generally to the use of curable elastomeric materials to help affix protective mouth guards to the teeth of athletes while providing added comfort, cushioning and soft-tissue protection. The invention is generally compatible with any conventional sport mouth guard and any curable elastomeric materials, although conventional denture reline materials are preferred and silicone-based denture reline materials are more preferred. The mouth guards can be non-custom fitted mouth guards, thermally deformable mouth guards (e.g. boil and bite type mouth guards), and custom-fitted mouth guards, including both single layer and laminated custom-fitted mouth guards or trays.

Accordingly, one preferred method for conforming a protective mouth guard to fit securely to one or more teeth within a mouth comprises first providing a mouth guard, the mouth guard having a first surface which is adapted to contact the occlusal surface of at least one tooth. Next, a curable elastomeric material is introduced into the mouth guard, such as by applying it into the trough and/or against the front wall that covers the front of the person's teeth and optionally against the back wall that covers the lingual surfaces of the teeth. The mouth guard is then inserted into the person's mouth to form an impression of the person's teeth while the elastomeric material is sufficiently uncured or undercured such that it is readily deformable without causing the elastomeric material to fracture or tear.

In a preferred embodiment, the denture reline material comprises a multi-part composition (e.g., a two-part composition) comprising at least one polysiloxane monomer, oligomer or polymer and at least one chemical curing agent that causes the polysiloxane material to polymerize and/or cross-link so as to form a somewhat more rigid material conforming to the dental impression.

Even when fully cured, the elastomeric material preferably remains sufficiently resilient in order to provide additional cushioning of the person's teeth. It will typically be substantially more resilient, flexible and cushioning than the mouth guard. In this way, the reline material provides increased cushioning compared to the mouth guard material, while the mouth guard material provides greater durability and resistance to breakage compared to the reline material. In this way, the two different materials provide a synergistic effect that takes advantage of the different materials properties of the mouth guard material, on the one hand, and the elastomeric material, on the other.

The mouth guard can comprise upper or lower troughs, or both, to protect the teeth and gums of the user, and the reline material can be applied to all or only a portion of the mouth guard that contacts a user's teeth and gums. The mouth guard may be substantially U-shaped so as to overlap both the frontal and lingual surfaces of the teeth, or it may be substantially L-shaped so as to only overlap the frontal surfaces of the teeth.

The reline material can be applied not only to a new mouth guard, but can be used to repair or improve a mouth guard having a defect in its previously applied denture reline material. Such a defect typically is a point where denture reline material is desired but is absent or damaged.

Kits within the scope of the invention may include at least one curable elastomeric material, at least one mouth guard or mouth guard precursor (e.g., at least one polymeric sheet material that can be formed into a custom-fitted mouth guard from a stone cast representative of the person's teeth), and other desired components.

These and other features of the present invention will become more fully apparent from the following description and appended claims, or may be learned by the practice of the invention as set forth hereinafter.

### DETAILED DESCRIPTION OF THE INVENTION

The present invention relates generally to methods and kits for use in preparing or treating a mouth guard so as to provide a better and more accurate fit against the user's teeth and also to provide additional cushioning of the user's teeth. The methods involve the use of a curable elastomeric material that is placed within a mouth guard in order to take an impression of at least a portion of the person's teeth. Upon curing, the resulting mouth guard more precisely conforms to the person's teeth. This assists in retaining the mouth guard over the person's teeth, which by itself increases protection of the person's teeth. In addition, the elastomeric material preferably provides additional cushioning and shock absorption compared to a mouth guard placed directly over the person's teeth to the teeth of athletes. The reline material preferably comprises silicone-based reline materials commonly used in dentistry for affixing dentures.

Conventional mouth guards come in a variety of shapes and designs. The present invention is not limited to any particular design, so long as it contains at least one tooth or jaw-contacting surface that can support a denture reline material. The mouth guards and mouth guard features described herein are not intended to limit the invention, but are presented simply to assist in describing the invention.

Mouth guards are usually fabricated from special medical grade rubber, polyurethane, vinyl or silicone materials. The silicone materials are generally more compressible and, consequently, softer. One such mouth guard is a large-scale production mouth guard that is made from a thermoplastic material that conforms to the user's mouth and cushions the user's teeth from impact. The material is initially formed into a single U-shaped channel. It is heated to a temperature higher than body temperature. While in a soft and moldable condition, it is placed in the mouth and formed by biting, sucking and pressure. At body temperature, it is shape-retaining, tough, flexible, and resilient.

Other mouth guards can be formed of more durable or less flexible materials and can comprise upper and lower channels rather than a single channel. Thus, one preferred embodiment of the invention includes a mouth guard having an upper section which is mountable on the upper jaw. Preferably, opposing the upper section is a lower section which is mountable mounted on the lower jaw. Each of the lower and upper sections has one anterior region and two posterior regions, forming a U-shape that conforms to the shape of the upper or lower jaw.

In the alternative, the mouth guards can have other cross sections or configurations so long as they provide a desired level of protection of at least a portion of the person's teeth. For example, the mouth guards can have an L-shaped configuration.

There are several conventional classes of mouthguards including stock, “boil and bite,” single layer custom-fitted, and laminated custom-fitted. Stock mouthguards require no special preparation to conform the mouthguard to a user's mouth. A user simply buys one in the closest size and then cuts or otherwise alters the mouthguard for comfort. Boil and bite mouthguards, as discussed hereinabove, involve heating a mouthguard before insertion in the mouth to soften, biting down on the softened mouthguard to form a dental impression, and removing the mouthguard so that is cools and hardens to retain the dental impression.

Custom-made single layer mouthguards are dentist made and usually are formed by first making an impression of the upper teeth. A rigid model is then formed from the impression a sheet of mouthguard material is then heated and vacuumed over the model. The excess material is trimmed and the guard is polished for delivery.

Multiple-layered pressure laminated mouthguards, such as the Maxxgard™ type IV mouthguard available from Maxxgard™, are made with the same model taken for the single-layered mouthguard. The main difference is the use of a special machine that presses multiple layers of guard material over the models to build more protection into the guard.

Further examples of mouth guards that may be used within the scope of the invention are set forth in U.S. Pat. No. 3,312,218 to Jacobs, U.S. Pat. No. 3,379,193 to Monaghan, U.S. Pat. No. 4,955,393 to Adell, U.S. Pat. No. 5,562,449 to Jacobs et al., U.S. Pat. No. 5,616,027 to Jacobs et al., and U.S. Pat. No. 5,769,633 to Jacobs et al. For purposes of disclosing mouth guards that may be used in conjunction with the inventive methods and kits, the foregoing patents are incorporated herein by reference.

The use of denture reline materials and other curable elastomeric materials according to the invention enables the treated mouth guard to more closely conform to the lingual, buccal, and interproximal regions compared to mouth guards that are placed directly over the person's teeth.

Generally, desired characteristics for denture relining materials include permanent resiliency, high dimensional stability, adequate adhesion to the mouth guard base polymer, adequate wetability in the oral environment, and compatibility with oral tissue, i.e., non-toxic, non-irritant, and resistant to bacterial growth.

Examples of suitable denture reline materials include silicone-based reline materials include, but are not limited to, UFI GEL SC, which is manufactured by VOVO GmbH, located in Cuxhaven, Germany; GC RELINE SOFT and GC RELINE EXTRA SOFT, which are manufactured by GC America, Inc., located in Alsip, Ill., and MOLLOSIL PLUS and MOLLOPLAST-B which are marketed by Hydro-Cast Dental Products, located in Kansas City, Mo., NOVUS, by The Hygenic Group, LYNAL by L.D. Caulk/Dentsply, and VISCO-GE by Ash/Dentsply. Other reline materials include such materials as a (meth)acrylic acid ester polymer, a fluorine-contained resin, a polyolefin type resin, a silicone rubber, the materials disclosed by U.S. Pat. No. 5,952,400 to Hosoi et al. and the like. For purposes of disclosing curable elastomeric materials that may be used in conjunction with the inventive methods and kits, the foregoing patent is incorporated herein by reference.

Silicone polymer materials are preferred because they tend to be relatively stable in the oral cavity. Examples of silicone polymers include polysiloxanes such as vinyl-terminated polydimethylsiloxane and hydroxyl-terminated polydimethylsiloxane.

Vinyl-terminated siloxane polymer mixes are typically heat cured and contain an amount of benzoyl peroxide which acts as a free-radical polymerization and cross linking initiator. Upon application of heat, the initiator promotes the cross linking of the polymer molecules and thus converts the linear polymer into a highly resilient elastomer. The heat activated cross linking reaction is in the nature of a pure addition reaction which does not produce any by-product. These liners are often referred to as heat curing silicone soft liners.

The curing of hydroxyl-terminated polydimethylsiloxanes, on the other hand, is in the nature of a condensation reaction. Although it requires no heat, the reaction requires a cross linking agent, e.g., tetraethyl silicate, and a catalyst, such as dibutyl tin dilaurate. Upon the mixing of the polysiloxane with the cross linking agent and the catalyst, the catalyst initiates the cross linking of the polysiloxane molecules at room temperature and converts the linear polymer into a highly resilient elastomer. These liners are often called cold curing silicone soft liners.

Methods according to the invention incorporate the above discussed reline materials or other elastomeric materials to increase the comfort and retention of mouth guards. One preferred method comprises first providing a mouth guard, the mouth guard having a first surface which is adapted to contact the occlusal surface of at least one tooth. A curable elastomeric material is then introduced into the mouth guard, such as by applying it into the trough and/or to the front and back surfaces of the mouth guard. The mouth guard is then inserted into a mouth to form a dental impression in the curable elastomeric material. The curable elastomeric material is preferably a silicone-based denture reline material as described hereinabove.

In the case of a chemical cure elastomeric material, the material is typically a multi-part material (e.g. two-part material) that is prepared just prior to introducing it into the mouth guard. Once a dental impression is made, such materials will simply cure on their own at room temperature. Accordingly, the mouth guard can be left in the person's mouth in order for the reline material to at least partially cure. It may be advantageous to allow sufficient curing in order to prevent unwanted deformation of the dental impression while removing the mouth guard from the person's teeth. Nevertheless, it will be appreciated that the method is not limited to any particular curing regimen.

In the case of a thermally cured elastomeric material, it may be necessary to remove the mouth guard from the person's mouth and then heat the material in order to promote polymerization and/or cross-linking of the elastomeric material.

The reline material can be applied not only to a new mouth guard, but can be used to repair or improve to a mouth guard having a defect in its previously applied denture reline material. Such a defect typically is a point where a denture reline material is desired but is absent or damaged (e.g., as a result of underfilling the mouth guard with elastomeric material initially and/or subsequent damage during use).

The curable elastomeric material can be introduced directly into the mouth guard, or an adhesive material known in the art can be applied to the mouth guard preparatory to introducing the curable elastomeric material into the mouth guard in order to increase the bond between the elastomeric material and the mouth guard. Excess elastomeric material (e.g., flashing) can be trimmed away from the mouth guard as desired in order to increase comfort and/or improve the fit against the person's teeth.

It may be advantageous to provide a kit that can be used to form mouth guards according to the invention having increased retention and/or cushioning. For example a mouth guard or mouth guard precursor can be provided together with a curable elastomeric material. The mouth guard may be a non-custom fitting mouth guard, a thermally deformable preformed mouth guard (e.g., a boil and bite mouth guard), or a custom-fitted mouth guard (e.g., a mouth guard formed from a stone cast representative of the person's teeth, such as by conventional vacuum forming methods). The custom-fitted mouth guard can be a single-layer mouth guard that is formed by vacuum forming a single layer of a sheet material, or it may be a multiple layered, pressure laminated mouth guard.

In the alternative, the dental kits according to the invention may include a mouth guard precursor, such as one or more polymeric sheets that can be formed into a custom-fitted mouth guard from a stone cast representative of the person's teeth. Multiple layers of one or more different types of polymeric materials can be used to form a multiple-layered pressure-laminated mouth guard.

In addition, the kits may include any other desirable component, including one or more of a dental impression material used to form a stone cast representative of the person's teeth, a plaster or other hardenable material suitable for making the stone cast, and/or an adhesive for increasing the bond between the mouth guard and the elastomeric material.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A method for treating a protective mouth guard to more precisely fit and provide increased cushioning against a person's teeth, comprising:
providing a protective mouth guard configured so as to cover at least a portion of a person's teeth;
introducing a quantity of a curable elastomeric material into the mouth guard;
placing the mouth guard over the person's teeth in a manner so that the curable elastomeric material forms an impression of at least a portion of the person's teeth; and
allowing the curable elastomeric material to at least partially cure.

2. A method as defined in claim 1, wherein the protective mouth guard comprises a non-custom mouth guard, a thermally deformable mouth guard, or a custom-fitted mouth guard.

3. A method as defined in claim 1, wherein at least a portion of the protective mouth guard is substantially U-shaped.

4. A method as defined in claim 1, wherein at least a portion of the protective mouth guard is substantially L-shaped.

5. A method as defined in claim 1, wherein the protective mouth guard is configured so as to cover at least a portion of the person's upper or lower teeth.

6. A method as defined in claim 1, wherein the protective mouth guard is configured so as to cover at least a portion of both the person's upper and lower teeth.

7. A method as defined in claim 1, wherein the protective mouth guard is a sport mouth guard sized and configured so as to protect a person's teeth during athletic events.

8. A method as defined in claim 1, wherein the curable elastomeric material is initially flowable when first introduced into the mouth guard.

9. A method as defined in claim 1, wherein the curable elastomeric material comprises at least one silicon-based polymer.

10. A method as defined in claim 9, wherein the silicon-based polymer comprises at least one polysiloxane.

11. A method as defined in claim 9, wherein the silicon-based polymer comprises a multi-part composition that is mixed together just prior to introducing it into the protective mouth guard.

12. A method as defined in claim 1, further including removing the mouth guard from the person's mouth after the curable elastomeric material has formed the impression of at least a portion of the person's teeth but before it has fully cured in order for the curable elastomeric material to continue curing outside the person's mouth.

13. A method as defined in claim 1, further comprising applying an adhesive material to the mouth guard prior to introducing the curable elastomeric material therein in order to increase bonding between the mouth guard and the elastomeric material.

14. A method as defined in claim 1, wherein the mouth guard is substantially more rigid and durable than the cured elastomeric material.

15. A method for treating a protective mouth guard to more precisely fit and provide increased cushioning against a person's teeth, comprising:
providing a custom-fitted protective mouth guard configured so as to cover at least a portion of a person's teeth;
introducing a quantity of a curable elastomeric material into the mouth guard;
placing the mouth guard over the person's teeth in a manner so that the curable elastomeric material forms an impression of at least a portion of the person's teeth; and
allowing the curable elastomeric material to at least partially cure.

16. A method as defined in claim 15, wherein the custom-fitted protective mouth guard is formed from a stone cast that is representative of at least a portion of the person's teeth.

17. A method as defined in claim 15, wherein the curable elastomeric material comprises at least one silicone-based polymer.

18. A kit for use in forming a protective mouth guard that more precisely fits and provides increased cushioning against a person's teeth, comprising:
at least one mouth guard or mouth guard precursor; and
at least one curable elastomeric material that can be placed into a mouth guard so as to form an impression of at least a portion of the person's teeth and that will at least partially cure so as to substantially maintain the impression over time.

19. A kit as defined in claim 18, wherein the mouth guard precursor comprises at least one sheet material that can be formed into a custom-fitted mouth guard from a stone cast that is representative of at least a portion of the person's teeth.

20. A kit as defined in claim 18, wherein the curable elastomeric material comprises at least one silicone-based polymer.
